(19) United States
(12) Patent Application Publication
(10) Pub. No.: US 2013/0021570 A1
(43) Pub. Date: Jan. 24, 2013

(54) Pixel Electrode And Liquid Crystal Display Panel

(71) Applicant: Xin Zhang, Shenzhen City (CN)

(72) Inventor: Xin Zhang, Shenzhen City (CN)

(73) Assignee: SHANGHAI TIANMA MICRO-ELECTRONICS CO., LTD., Shanghai City (CN)

(21) Appl. No.: 13/381,888

(22) PCT Filed: Sep. 30, 2011
(86) PCT No.: PCT/CN2011/080392

§ 371 Date: Dec. 30, 2011

(30) Foreign Application Priority Data
Jul. 18, 2011 (CN) 2011102003706

(51) Int. Cl. G02F 1/1343

(52) U.S. Cl. 349/139

(57) ABSTRACT

A pixel electrode includes strip-like horizontal and vertical main trucks, which perpendicularly intersect at an intersection point coincident with centers of the main trucks. Four pixel domains are formed by being equally divided by the main trunks. Each pixel domain includes a plurality of flat-laid strip-like branches extending outward at the same included angle with respect to the horizontal main trunk. A spacing distance is formed between adjacent branches. Connection portions between the branches and the horizontal or vertical main trunk have a width less than width of body sections of the branches in order to overcome the technical problem of prior art that liquid crystals at locations close to left and right sides of the vertical main trunk at the center of pixel compress each other and form disclination lines and thus affecting the efficiency of liquid crystal, so as to improve efficiency of liquid crystal.

### CROSS REFERENCES TO RELATED APPLICATIONS

This application claims the priority of Chinese Patent Application No. 201110200370.6, of which the title is “A Pixel Electrode and Liquid Crystal Display Panel”, filed with Chinese Patent Office on Jul. 18, 2011, which, in its entirety, is hereby incorporated for reference.

### BACKGROUND OF THE INVENTION

1. Field of the Invention

The present invention relates to the field of liquid crystal displaying techniques, and in particular to a pixel electrode and a liquid crystal display panel.

2. The Related Arts

Liquid crystal displays are gradually getting wide applications as a displaying device for various electronic devices, such as mobile phones, personal digital assistants (PDAs), digital cameras, computer monitor screens, or notebook computer screens. A liquid crystal display device comprises a backlight module and a liquid crystal display panel. The liquid crystal display panel is formed of two substrates and a layer of liquid crystal filled between the two substrates. The manufacturing techniques of the liquid crystal display panel are very diverse and a polymer stabilized vertical alignment (PSVA) liquid crystal display panel is the most common one.

As shown in FIG. 1, FIG. 1 is a schematic view showing a conventional structure of PSVA mode liquid crystal display panel. A typical pixel electrode of PSVA mode liquid crystal display panel is arranged as a snow flake like configuration, which is composed of three portions, including a vertical main trunk 20, a horizontal main trunk 10, and strip-like branches 30 that include an angle of ±45 degrees or ±135 degrees with respect to the x axis. The vertical main trunk 10 and the horizontal main trunk 20 equally divide the pixel area into four domains and each domain is formed by laying flat the electrode branches 113 of 45 degree inclination. The snow flake like configuration shown in FIG. 1 is an electrode arrangement of up-down and left-right mirror symmetry.

FIG. 2 is a schematic view illustrating orientation of liquid crystal with a voltage (0 to 4V) applied to the pixel electrode of FIG. 1. As shown in FIG. 2, when the snow flake like pixel electrode that is generally adopted is energized, liquid crystal shows orientation that is gradually inclined from outside of the pixel electrode toward inside of the pixel electrode and the angle of inclination is along the direction of the strip-like branches. The inclination directions of liquid crystal of the four domains with respect to the horizontal main trunk are respectively ±45 degrees and ±135 degrees and all point to a central zone of the pixel. As shown in FIG. 2, the angles of the orientations of liquid crystal with respect to the horizontal main trunk (X axis) are: −135 degrees for the first quadrant, −45 degrees for the second quadrant, 45 degrees for the third quadrant, and 135 degrees for the fourth quadrant.

The known techniques heavily rely on the centrally located vertical main trunk and horizontal main trunk. However, the two main trunks are light-blocked areas, because the liquid crystals within the two main trunks are oriented in the directions of the main trunks, which respectively include an angle of 0 degree and 90 degrees with respect to the horizontal main trunk, while upper and lower polarization plates are set to respectively include an angle of 0 degree and 90 degrees with respect to the horizontal main trunk. Consequently, the transmittance formula of regular VA liquid crystal can be used to figure out that the transmittance at this area is null and this leads to reduction of opening rate. Since the orientations of the liquid crystals within the two main trunks are respectively of included angles of 0 degree and 90 degrees with respect to the horizontal main trunk, which are different from the orientations of the strip-like branches, making it easy to occur disclination lines, namely the liquid crystals at locations close to the left and right sides of the vertical main trunk at the center of the pixel compressing each other to thereby form the disclination lines, which affect the efficiency of liquid crystal.

### SUMMARY OF THE INVENTION

The present invention provides a pixel electrode and a liquid crystal display panel, which effectively overcome the technical problem of the prior art that the liquid crystals at locations close to the left and right sides of the vertical main trunk at the center of the pixel compress each other to thereby form disclination lines, which affect the efficiency of liquid crystal.

To overcome the above technical problem, the present invention provides a pixel electrode. The pixel electrode comprises a strip-like horizontal main trunk and a strip-like vertical main trunk, which perpendicularly intersect, an intersection point of the horizontal main trunk and the vertical main trunk being coincident with a center point of the horizontal main trunk and a center point of the vertical main trunk; in four pixel domains that are formed by being equally divided by the perpendicular intersection of the horizontal main trunk and the vertical main trunk, each of the pixel domains comprising a plurality of flat-laid strip-like branches, the plurality of strip-like branches of each of the pixel domains extending outward at a same included angle with respect to the horizontal main trunk, the plurality of strip-like branches having a spacing distance between adjacent ones; connection portions between the strip-like branches and the horizontal main trunk or the vertical main trunk having a width less than width of body sections of the strip-like branches.

Preferably, the connection portion of each of the strip-like branches is a polygon having width gradually decreasing in a direction of extension toward center of the strip-like branch.

Preferably, the polygon is a quadrilateral and connection between the quadrilateral and the horizontal main trunk or the vertical main trunk has width that is less than width of a connection thereof with the body section.

Preferably, the connection portions of different strip-like branches have sizes that are different or identical.

Preferably, the plurality of strip-like branches forms an included angle of 45 degrees with respect to the horizontal main trunk and the vertical main trunk, and the plurality of strip-like branches of each of the pixel domains is arranged parallel.

Preferably, the plurality of strips of each of the pixel domains has identical spacing between adjacent ones.

Preferably, the plurality of strips of each of the pixel domains has different spacing between every two strips.

Preferably, the four pixel domains that are formed by being equally divided by the perpendicular intersection of the horizontal main trunk and the vertical main trunk are of mirror symmetry in up-down direction and left-right direction.

Preferably, the pixel electrode, as a whole, shows a snow flake like configuration.

Correspondingly, an embodiment of the present invention provides a liquid crystal display panel, which comprises a pixel electrode described above.

Practicing the embodiments of the present invention provides the following advantages:

With an arrangement that an end of the strip-like branch that intersects the horizontal main trunk or the vertical main trunk has a width that is less than the width of the strip-like branch, namely an arrangement that an end of the strip-like branch gets thinner at location close to the main trunk, the liquid crystal at such a location can be better oriented and is difficult to induce compression in an opposite direction, thereby helping to suppress the occurrence of disclination lines at the center of the pixel and thus effectively overcoming the technical problem that liquid crystals at locations close to left and right sides of the vertical main trunk at the center of pixel compress each other and form disclination lines and thus affecting the efficiency of liquid crystal, so as to improve efficiency of liquid crystal.

### BRIEF DESCRIPTION OF THE DRAWINGS

To more clearly describe the technical solution of the embodiments according to the present invention or the prior art techniques, a brief description of the drawings that are necessary for the illustration of the embodiments or the prior art will be given as follows. Apparently, the drawings described below show only embodiments of the present invention and for those having ordinary skills in the field, other drawings may be easily obtained from these drawings without paying any creative effort.

FIG. 1 is a schematic view showing a conventional PSVA (Polymer Stabilized Vertical Alignment) mode liquid crystal display panel;

FIG. 2 is a schematic view illustrating orientation of liquid crystal with a voltage applied to the pixel electrode of FIG. 1;

FIG. 3 is a schematic plan view illustrating a pixel electrode according to an embodiment of the present invention;

FIG. 4 is an enlarged view of a phantom line enclosed portion of FIG. 3; and

FIG. 5 is a schematic plan view illustrating a liquid crystal display panel according to an embodiment of the present invention.

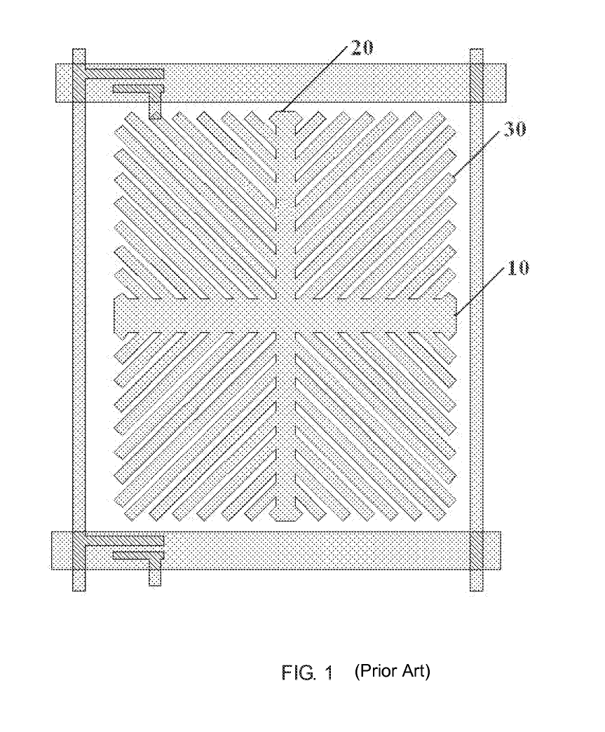

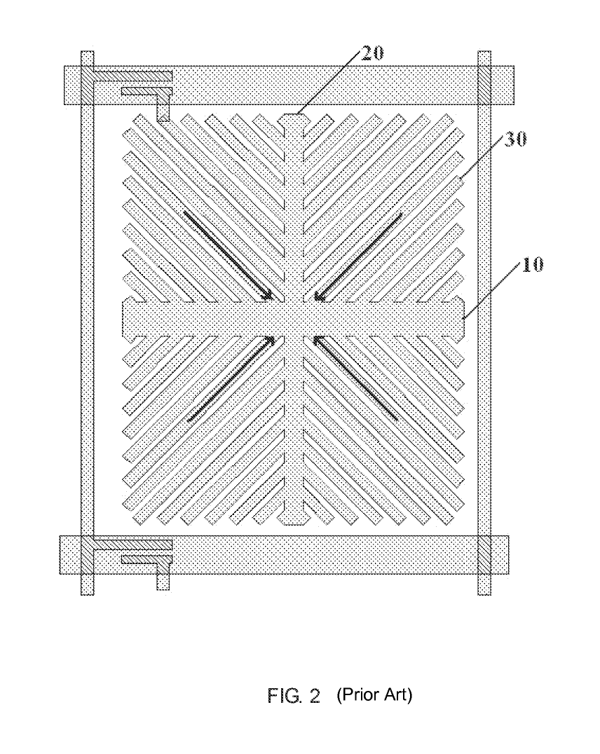

### DETAILED DESCRIPTION OF THE PREFERRED EMBODIMENTS

A liquid crystal display device comprises a backlight module and a liquid crystal display panel. The liquid crystal display panel is formed of first and second substrates that are arranged to oppose each other and a layer of liquid crystal filled between the two substrates. The second substrate has a displaying zone, which comprises a plurality of pixel areas, in which thin film transistors and pixel electrodes are provided. In view of the problem of prior art that liquid crystals at locations close to left and right sides of a vertical main trunk at the center of a pixel compress each other to thereby form disclination lines, which affect the efficiency of liquid crystal, the present invention provides a novel pixel electrode and a liquid crystal display panel comprising the pixel electrode in order to effectively overcome the problem.

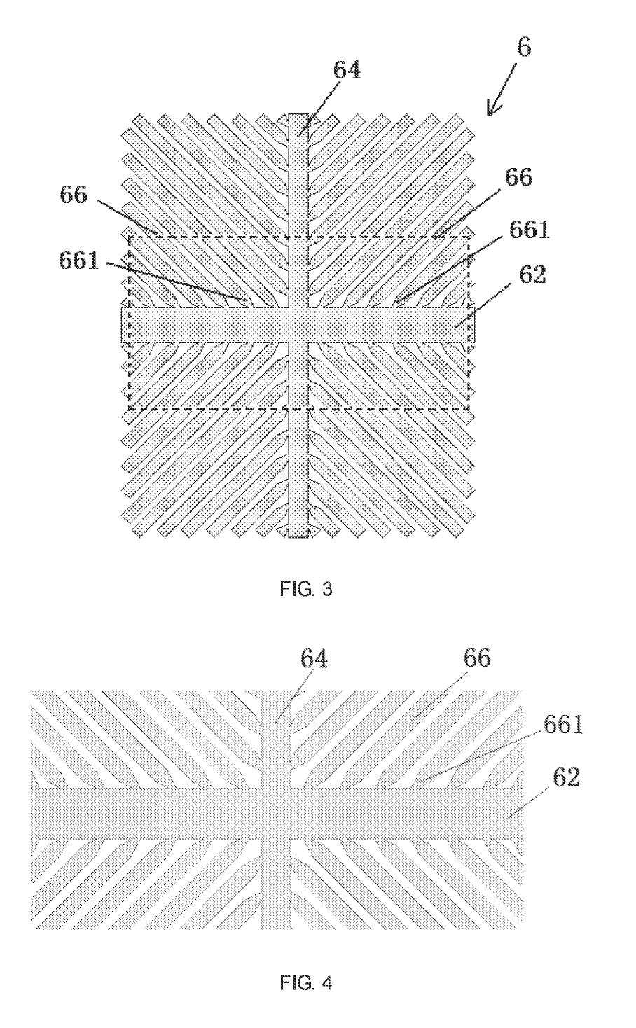

As shown in FIG. 3, a schematic plan view illustrating a pixel electrode according to an embodiment of the present invention is shown. The pixel electrode 6 comprises a strip-like horizontal main trunk 62 and a strip-like vertical main trunk 64, which perpendicularly intersect. The intersection point of the horizontal main trunk 62 and the vertical main trunk 64 is coincident with the center point of the horizontal main trunk 62 and the center point of the vertical main trunk 64. In four pixel domains that are formed by being equally divided by the perpendicular intersection of the horizontal main trunk 62 and the vertical main trunk 64, each pixel domain comprises a plurality of flat-laid strip-like branches 66. The plurality of strip-like branches 66 of each pixel domain extends outward at the same included angle with respect to the horizontal main trunk 62. The plurality of strip-like branches 66 has a spacing distance between adjacent ones. Connection portions 661 between the strip-like branches 66 and the horizontal main trunk 62 or the vertical man trunk 64 have a width less than width of body sections of the strip-like branches 66.

Specifically, as shown in FIG. 4, which is an enlarged view of a phantom line enclosed portion of FIG. 3, the connection portions 661 between the strip-like branches 66 and the horizontal main trunk 62 or the vertical main trunk 64, which are the ends 661 of the strip-like branches 66 that are close to the main trunk, is a polygon of which the width gradually decreases in a direction of extension toward center of the strip-like branches 66, such as a quadrilateral. The connection between the quadrilateral and the horizontal main trunk or the vertical main trunk has a width that is less than a width of the connection thereof with the body section. Other polygons are certainly applicable.

It is noted here that FIGS. 3 and 4 are only one of the embodiments of the present invention. The connection portions 661 of the strip-like branches 66 and the horizontal main trunk 62 or the vertical main trunk 64 comprise, but not limited to, the quadrilateral structure described above, and can be any arbitrary polygons, such as a triangle, a rhombus, a rectangle, a square, or a hexagon, provided an effect that the connection portion of the strip-like branch is reduced is obtained.

Further, the connection portions of different strip-like branches can be of different sizes, or the same size. The spacing between adjacent ones of the plurality of strip-like branches in each of the pixel domains can be the same or different.

It is noted that in the embodiment of the present invention, the material that makes the pixel electrode includes, but not limited to, indium tin oxide (ITO) or indium zinc oxide or amorphous indium tin oxide. The material making the pixel electrode being ITO will be taken as an example for the following description. In other words, the horizontal main trunk 62, the vertical main trunk 64, and the strip-like branches 66 shown in FIGS. 3 and 4 are all areas constituted by ITO. In the areas constituted by ITO, the liquid crystals, with a voltage applied thereto, incline toward inside of the pixel in a direction of the pixel electrode (strip-like branch), namely inclining toward the center. Since the width at the end of the strip-like branch 66 that intersects the horizontal main trunk 62 or the vertical main trunk 64 is less than the width of the strip-like branch 66, namely the branch getting thinner at location close to the main trunk, the liquid crystal at such a location can be better oriented and is difficult to induce compression in an opposite direction, thereby helping to suppress the occurrence of disclination lines at the center of the pixel and thus effectively overcoming the technical problem that liquid crystals at locations close to left and right sides of the vertical main trunk at the center of pixel compress each other and form disclination lines, which affect the efficiency of liquid crystal, so as to improve efficiency of liquid crystal.

The plurality of flat-laid strip-like branches 66 of each of the pixel domains forms an include angle with respect to the horizontal main trunk 62, which includes, but not limited to, 45 degrees. FIGS. 3 and 4 show an example of 45 degrees for the included angle.

Further, as shown in FIG. 3, the four pixel domains that are formed by being equally divided by the perpendicular intersection of the horizontal main trunk 62 and the vertical main trunk 64 are of mirror symmetry in up-down direction and left-right direction, namely the zones on the opposite sides of the horizontal main trunk 62 being mirror symmetric and the zones on the opposite sides of the vertical main trunk 64 being also mirror symmetric. The pixel electrode, as a whole, shows a snow flake like configuration.

The pixel electrode according to the embodiment of the present invention is applicable to a PSVA liquid crystal display panel or a PVA (Pattern Vertical Alignment) liquid crystal display panel.

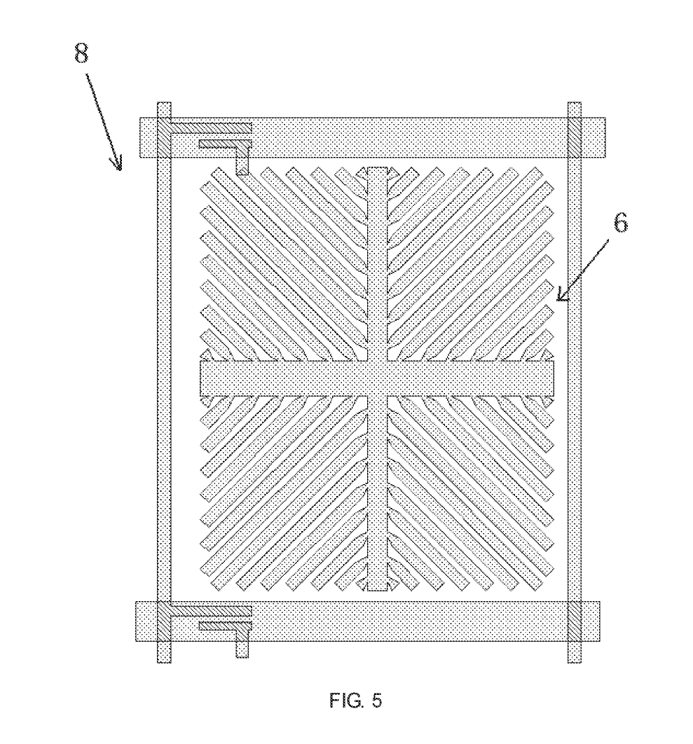

FIG. 5 shows a schematic view that illustrates a liquid crystal display panel according to an embodiment of the present invention. The liquid crystal display panel 8 comprises the pixel electrode 6 according to the embodiment of the present invention. The details of the structure of the pixel electrode 6 may refer to the previous embodiment of the pixel electrode 6 and repeated description is omitted here. It is noted here that the liquid crystal display panel 8 also comprises a data line, a scan line, and a switch unit.

In summary, with an arrangement that an end of the strip-like branch that intersects the horizontal main trunk or the vertical main trunk has a width that is less than the width of the strip-like branch, namely an arrangement that an end of the strip-like branch gets thinner at location close to the main trunk, the liquid crystal at such a location can be better oriented and is difficult to induce compression in an opposite direction, thereby helping to suppress the occurrence of disclination lines at the center of the pixel and thus effectively overcoming the technical problem that liquid crystals at locations close to left and right sides of the vertical main trunk at the center of pixel compress each other and form disclination lines and thus affecting the efficiency of liquid crystal, so as to improve efficiency of liquid crystal.

Although the present invention has been described with reference to the preferred embodiments thereof, the preferred embodiments are not to limit the scope of the present invention. Various variations and modifications can be contemplated by those having ordinary skills in the art without departing from the spirits and scope of the present invention and thus, the scope of protection provided by the present invention is determined by the appended claims.

The description given above is preferred embodiments of the present invention and it is noted that for those having ordinary skills of the art, numerous improvements and modifications can be made without departing the principles of the present invention. Such improvements and modifications are considered within the scope of protection of the present invention.

1. A pixel electrode, wherein the pixel electrode comprises a strip-like horizontal main trunk and a strip-like vertical main trunk, which perpendicularly intersect, an intersection point of the horizontal main trunk and the vertical main trunk being coincident with a center point of the horizontal main trunk and a center point of the vertical main trunk; in four pixel domains that are formed by being equally divided by the perpendicular intersection of the horizontal main trunk and the vertical main trunk, each of the pixel domains comprising a plurality of flat-laid strip-like branches, the plurality of strip-like branches of each of the pixel domains extending outward at a same included angle with respect to the horizontal main trunk, the plurality of strip-like branches having a spacing distance between adjacent ones; connection portions between the strip-like branches and the horizontal main trunk or the vertical main trunk having a width less than a width of body sections of the strip-like branches.

2. The pixel electrode as claimed in claim 1, wherein the connection portion of each of the strip-like branches is a polygon having width gradually decreasing in a direction of extension toward center of the strip-like branch.

3. The pixel electrode as claimed in claim 2, wherein the polygon is a quadrilateral and connection between the quadrilateral and the horizontal main trunk or the vertical main trunk has width that is less than width of a connection thereof with the body section.

4. The pixel electrode as claimed in claim 1, wherein the connection portions of different strip-like branches have sizes that are different or identical.

5. The pixel electrode as claimed in claim 1, wherein the plurality of strip-like branches forms an included angle of 45 degrees with respect to the horizontal main trunk and the vertical main trunk, the plurality of strip-like branches of each of the pixel domains being arranged parallel.

6. The pixel electrode as claimed in claim 5, wherein the plurality of strip-like branches of each of the pixel domains has identical spacing between adjacent ones.

7. The pixel electrode as claimed in claim 5, wherein the plurality of strip-like branches of each of the pixel domains has different spacing between every two strips.

8. The pixel electrode as claimed in claim 1, wherein the four pixel domains that are formed by being equally divided by the perpendicular intersection of the horizontal main trunk and the vertical main trunk are of mirror symmetry in up-down direction and left-right direction.

9. The pixel electrode as claimed in claim 8, wherein the pixel electrode shows a snow flake like configuration.

10. A liquid crystal display panel, wherein the liquid crystal display panel comprises the pixel electrode according to claim 1.
